(19) United States
(12) Patent Application Publication
(10) Pub. No.: US 2018/0236412 A1
(43) Pub. Date: Aug. 23, 2018

(54) RETRIEVABLE AERATION SYSTEM FOR WASTEWATER TREATMENT

(71) Applicants: Thomas E. Frankel, Poughkeepsie, NY (US); Seoungil Kang, Poughkeepsie, NY (US); Todd D. Ritter, Poughkeepsie, NY (US)

(72) Inventors: Thomas E. Frankel, Poughkeepsie, NY (US); Seoungil Kang, Poughkeepsie, NY (US); Todd D. Ritter, Poughkeepsie, NY (US)

(21) Appl. No.: 15/438,926

(22) Filed: Feb. 22, 2017

(51) Int. Cl. B01F 3/04; C02F 1/74; B01F 13/00

(52) U.S. Cl. CPC B01F 3/04241; C02F 1/74; B01F 13/0047; C02F 2201/008; B01F 2003/04297; B01F 2003/04319; B01F 2003/04872; B01F 2215/0052; B01F 2003/04276

(57) ABSTRACT

An apparatus for use with a wastewater treatment tank is described. The apparatus includes a track, pipe modules coupled to the track such that the pipe modules are translatable along the track, and diffusers attached to the pipe modules. Each pipe module defines a respective partially curved mating surface, a respective partially curved mating cavity, and a respective gas passage passing through it. The respective partially curved mating surface of a first pipe module is inserted into the respective partially curved mating cavity of a second pipe module, while the respective partially curved mating surface of the second pipe module is inserted into the respective partially curved mating cavity of a third pipe module. Each gas passage of the pipe modules is in gaseous communication with the other gas passages of the pipe modules. At the same time, each diffuser is in gaseous communication with the gas passages of the pipe modules.

### FIELD OF THE INVENTION

The present invention relates generally to wastewater treatment, and, more particularly, to retrievable wastewater aeration systems for use in wastewater treatment.

### BACKGROUND OF THE INVENTION

Maintenance of wastewater aeration systems typically requires that the associated wastewater treatment tank be drained in order to access diffusers and conduits at the bottom of the tank. Such maintenance can be very burdensome and costly. Most wastewater treatment facilities only allot small amounts of time to conduct such maintenance. Moreover, many wastewater treatment tanks were not properly designed with drains, meaning draining a wastewater treatment tank requires hiring a contractor with big pumps, and then spending hours or days hosing off the tank and shoveling solids off the floor to prepare it for entry by maintenance personnel. In many cases, time spent in the tank requires special confined-space training and/or certification with full safety equipment.

Considering these difficulties, wastewater aeration systems that may be retrieved from a wastewater treatment tank to allow maintenance outside the tank are becoming more popular and are also required by statute in a number of states when a plant is built without sufficient aeration tank redundancy. Such systems may be lifted from a tank via a winch, crane, or boom truck, sometimes in combination with a pontoon boat. Nevertheless, such liftable systems suffer from several disadvantages. They are typically formed from steel and concrete, and are therefore heavy, bulky, and expensive to manufacture. In addition, there are often a lot of support structures involved with these retrievable systems (e.g., frames, cables, and ropes), and these support structures can become entangled with rags in the wastewater. These rags can make the aeration system so heavy or bulky that it is impossible to lift. Land is also often scarce at wastewater treatment plants. Thus, there simply may not be enough room next to a wastewater treatment tank for placing the additional equipment involved in retrieving a liftable aeration system, and for maintaining the system once out of the tank.

For the foregoing reasons, there is a need for new retrievable aeration systems for use in treating wastewater.

### SUMMARY OF THE INVENTION

Embodiments of the present invention address the above-identified needs by providing novel retrievable aeration systems that may be easily retrieved-from and deployed-into wastewater treatment tanks via tracks that run into and adjacent to the wastewater treatment tanks.

Aspects of the invention are directed to an apparatus for use with a wastewater treatment tank. The apparatus comprises a track, a plurality of pipe modules coupled to the track such that the plurality of pipe modules are translatable along the track, and a plurality of diffusers attached to the plurality of pipe modules. Each pipe module of the plurality of pipe modules defines a respective partially curved mating surface, a respective partially curved mating cavity, and a respective gas passage passing therethrough. The respective partially curved mating surface of a first pipe module of the plurality of pipe modules is inserted into the respective partially curved mating cavity of a second pipe module of the plurality of pipe modules, while the respective partially curved mating surface of the second pipe module of the plurality of pipe modules is inserted into the respective partially curved mating cavity of a third pipe module of the plurality of pipe modules. Each gas passage of the plurality of pipe modules is in gaseous communication with the other gas passages of the plurality of pipe modules. Each diffuser of the plurality of diffusers is in gaseous communication with the gas passages of the plurality of pipe modules.

Additional aspects of the invention are directed to a method for treating wastewater in a wastewater treatment tank. A track is installed, and a plurality of pipe modules are coupled to the track such that the plurality of pipe modules are translatable along the track. Each pipe module of the plurality of pipe modules defines a respective partially curved mating surface, a respective partially curved mating cavity, and a respective gas passage passing therethrough. A plurality of diffusers are also attached to the plurality of pipe modules. Each pipe module of the plurality of pipe modules defines a respective partially curved mating surface, a respective partially curved mating cavity, and a respective gas passage passing therethrough. The respective partially curved mating surface of a first pipe module of the plurality of pipe modules is inserted into the respective partially curved mating cavity of a second pipe module of the plurality of pipe modules, while the respective partially curved mating surface of the second pipe module of the plurality of pipe modules is inserted into the respective partially curved mating cavity of a third pipe module of the plurality of pipe modules. Each gas passage of the plurality of pipe modules is in gaseous communication with the other gas passages of the plurality of pipe modules. Each diffuser of the plurality of diffusers is in gaseous communication with the gas passages of the plurality of pipe modules.

Even additional aspects of the invention are directed to a wastewater treatment system. The wastewater treatment system comprises a wastewater treatment tank, a track, a plurality of pipe modules coupled to the track such that the plurality of pipe modules are translatable along the track, and a plurality of diffusers attached to the plurality of pipe modules. A portion of the track occupies the wastewater treatment tank. Each pipe module of the plurality of pipe modules defines a respective partially curved mating surface, a respective partially curved mating cavity, and a respective gas passage passing therethrough. The respective partially curved mating surface of a first pipe module of the plurality of pipe modules is inserted into the respective partially curved mating cavity of a second pipe module of the plurality of pipe modules, while the respective partially curved mating surface of the second pipe module of the plurality of pipe modules is inserted into the respective partially curved mating cavity of a third pipe module of the plurality of pipe modules. Each gas passage of the plurality of pipe modules is in gaseous communication with the other gas passages of the plurality of pipe modules. Each diffuser of the plurality of diffusers is in gaseous communication with the gas passages of the plurality of pipe modules.

### BRIEF DESCRIPTION OF THE DRAWINGS

These and other features, aspects, and advantages of the present invention will become better understood with regard to the following description, appended claims, and accompanying drawings where:

FIG. 1 shows a perspective view of a retrievable aeration system in accordance with an illustrative embodiment of the invention with the retrievable aeration system in a maintenance state;

FIG. 2 shows a perspective view of the FIG. 1 retrievable aeration system with the retrievable aeration system being transitioned from the maintenance state to a deployed state;

FIG. 3 shows a perspective view of the FIG. 1 retrievable aeration system with the retrievable aeration system in the deployed state;

FIG. 4 shows a partially-broken perspective view of a portion of the retrievable aeration system near its winch with the retrievable aeration system in its maintenance state;

FIG. 5 shows a perspective view of a portion of the retrievable aeration system with the retrievable aeration system in its deployed state before connection to a source of pressurized air;

FIG. 6 shows a perspective view of a portion of the FIG. 1 retrievable aeration system with the retrievable aeration system in its deployed state and connected to the source of pressurized air;

FIG. 7 shows a perspective view of a portion of the FIG. 1 retrievable aeration system with several interconnected pipe modules and their tube diffusers;

FIG. 8 shows an exploded perspective view of two pipe modules and their associated tube diffusers in the FIG. 1 retrievable aeration system;

FIG. 9 shows a front elevational view of a pipe module and its associated tube diffusers in the FIG. 1 retrievable aeration system;

FIG. 10 shows a front perspective view of a pipe module in the FIG. 1 retrievable aeration system;

FIG. 11 shows a rear perspective view of a pipe module in the FIG. 1 retrievable aeration system;

FIG. 12 shows a partially broken side elevational view of several interconnected pipe modules in the FIG. 1 retrievable aeration system with the sectional cut occurring along the plane indicated in FIG. 7;

FIG. 13 shows a perspective view of one-half of a split flange in the FIG. 1 retrievable aeration system;

FIG. 14 shows a partially-broken perspective view of a portion of a retrievable aeration system in accordance with a first alternative illustrative embodiment of the invention;

FIG. 15 shows a sectional view of the FIG. 14 retrievable aeration system along the plane indicated in FIG. 14;

FIG. 16 shows a side elevational view of a portion of a retrievable aeration system in accordance with a second alternative illustrative embodiment of the invention;

FIG. 17 shows a sectional view of the FIG. 16 retrievable aeration system along the plane indicated in FIG. 16;

FIG. 18 shows a perspective view of a portion of a retrievable aeration system in accordance with a third illustrative embodiment of the invention;

FIG. 19 shows a perspective view of a retrievable aeration system similar to the FIG. 1 retrievable aeration system with a track made to parallel an edge of a wastewater treatment tank; and

FIG. 20 shows a perspective view of the FIG. 1 retrievable aeration system deployed in a covered wastewater treatment tank.

### DETAILED DESCRIPTION OF THE INVENTION

The present invention will be described with reference to illustrative embodiments. For this reason, numerous modifications can be made to these embodiments and the results will still come within the scope of the invention. No limitations with respect to the specific embodiments described herein are intended or should be inferred.

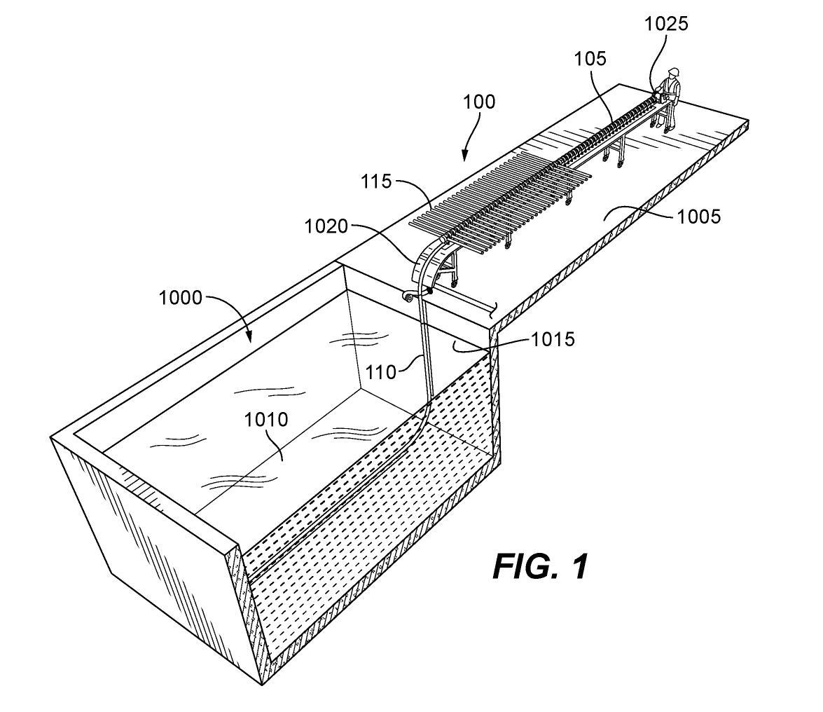

As used in the present description and the appended claims, the term “attached” means joined, connected, or bound to another object with or without intervening elements. The terms “above,” “lateral to,” “vertically,” and “parallel to” are referenced to a retrievable aeration system as the retrievable aeration system is oriented in FIGS. 1-3. The words “substantially parallel” mean parallel within plus or minus ten degrees.

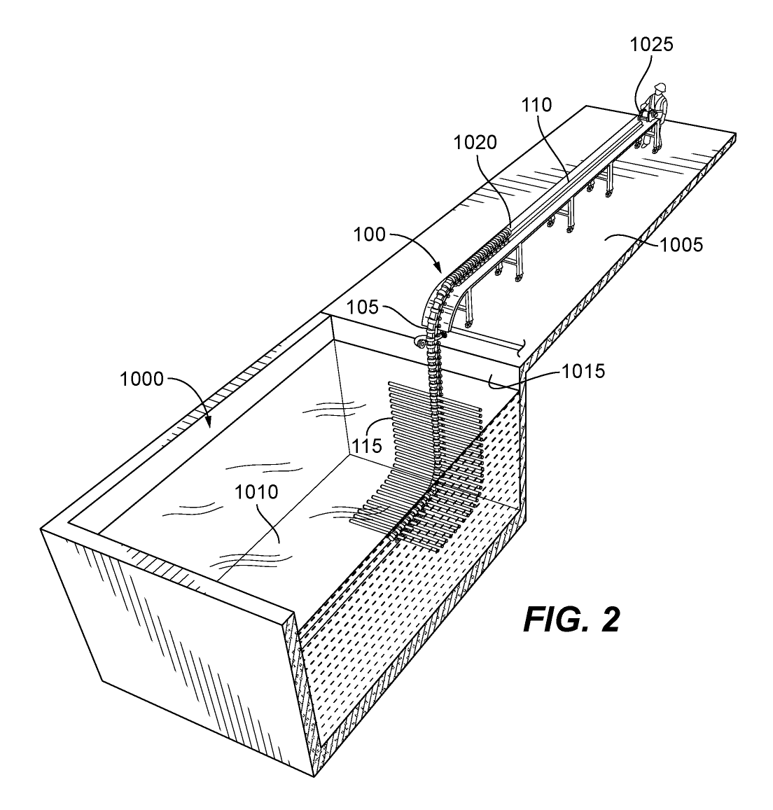

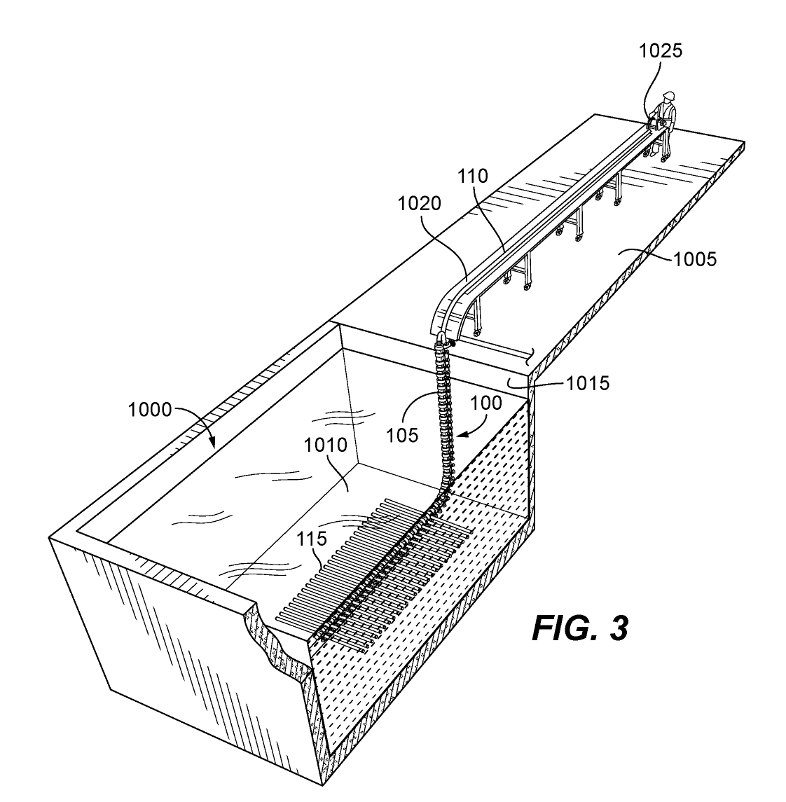

FIGS. 1-3 show perspective views of a retrievable aeration system 100 (an apparatus) in accordance with an illustrative embodiment of the invention in association with a wastewater treatment tank 1000. FIG. 1 shows the retrievable aeration system 100 in a maintenance state, while FIG. 2 shows the retrievable aeration system 100 being transitioned from the maintenance state to a deployed state, and FIG. 3 shows the retrievable aeration system 100 in the deployed state. The maintenance state of the retrievable aeration system 100 allows maintenance of the retrievable aeration system 100 to occur on a ledge 1005 (e.g., concrete walkway) next to the wastewater treatment tank 1000 (FIG. 1). Because maintenance can occur outside the wastewater treatment tank 1000, there is no need to drain the wastewater treatment tank 1000.

The retrievable aeration system 100 depends on a plurality of pipe modules 105 that are coupled to a track 110 such that the plurality of pipe modules 105 are translatable along the track 110 (i.e., the pipe modules 105 are translatably coupled to the track 110). As will be detailed below, these pipe modules 105 utilize a novel “ball and socket” means of interconnection that allows a train of pipe modules 105 to bend as it progresses along the track 110. The track 110 runs along a bottom 1010 of the wastewater treatment tank 1000, ascends vertically up a sidewall 1015 of the wastewater treatment tank 1000, and then runs above the ledge 1005 on a moveable table 1020, which supports the track 110 above the ledge 1005. A winch 1025 at an end of the moveable table 1020 aids with retrieval. A plurality of tube diffusers 115 are attached to about half of the pipe modules 105. These tube diffusers 115 are disposed just above the bottom 1010 of the wastewater treatment tank 1000 when the retrievable aeration system 100 is in its deployed state, as shown in FIG. 3.

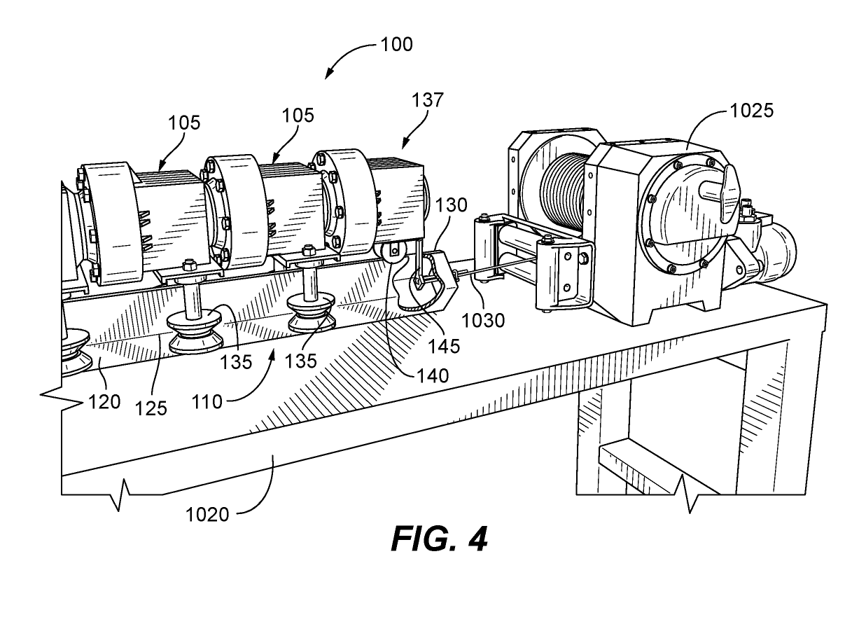

Additional details of the retrievable aeration system 100 and the wastewater treatment tank 1000 are shown in FIGS. 4-6. FIG. 4 shows a partially-broken perspective view of a portion of the retrievable aeration system 100 near the winch 1025 with the retrievable aeration system 100 in its retrieved maintenance state (the state shown in FIG. 1). The track 110 is generally diamond-shaped in cross-section (i.e., a parallelogram) with four external flat surfaces 120, three ninety-degree corners 125, and a slot 130 at its top. Two respective rollers 135 (i.e., rolling wheels) on each of the pipe modules 105 are pressed against two opposed corners 125 of the track 110 and allow the pipe modules 105 to easily roll along the track 110. A special winch-connecting module 137 positioned closest to the winch 1025 is a bit different from the others and includes a single top roller 140 as well as a tongue 145 that descends through the slot 130 in the top of the track 110 and into the interior of the track 110. A cable 1030 from the winch 1025 connects to the tongue 145.

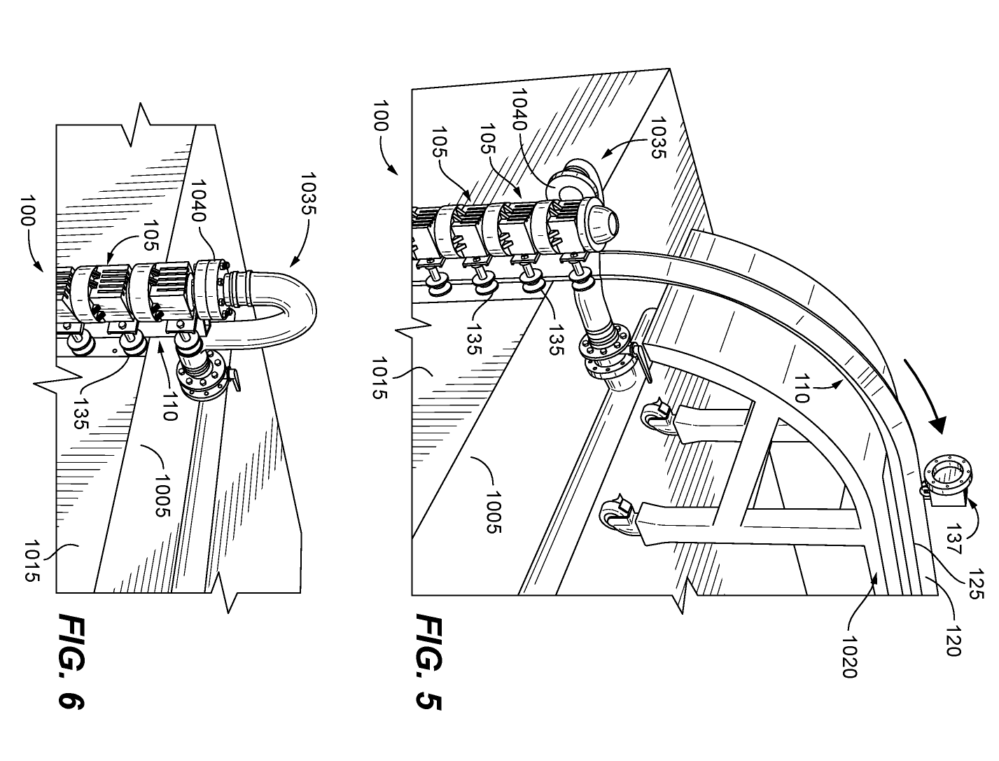

FIGS. 5 and 6 show perspective views of a portion of the retrievable aeration system 100 near a top edge of the wastewater treatment tank 1000 after the retrievable aeration system has been deployed (i.e., lowered) into the wastewater treatment tank (FIG. 3). In FIG. 5, the winch-connecting module 137 has been disconnected from the remainder of the pipe modules 105 and can be seen sitting atop the track 110 overlying the moveable table 1020. A source of pressurized air 1035 sits conveniently near the end of the train of pipe modules 105, and includes a flange 1040 that allows it to be connected to the endmost pipe module 105. The source of pressurized air 1035 may be connected to, for example, an air blower (not shown). FIG. 6 goes on to show the retrievable aeration system with the source of pressurized air 1035 attached to the pipe modules 105 and ready to supply pressurized air. In this figure, the moveable table 1020 and that portion of the track 110 overlying the ledge 1005 have been moved away. Once the retrievable aeration system 100 is supplied with pressurized air, the pressurized air will be transported by the train of pipe modules 105 to the tube diffusers 115 and ultimately released into wastewater in the wastewater treatment tank 1000 in the form of bubbles.

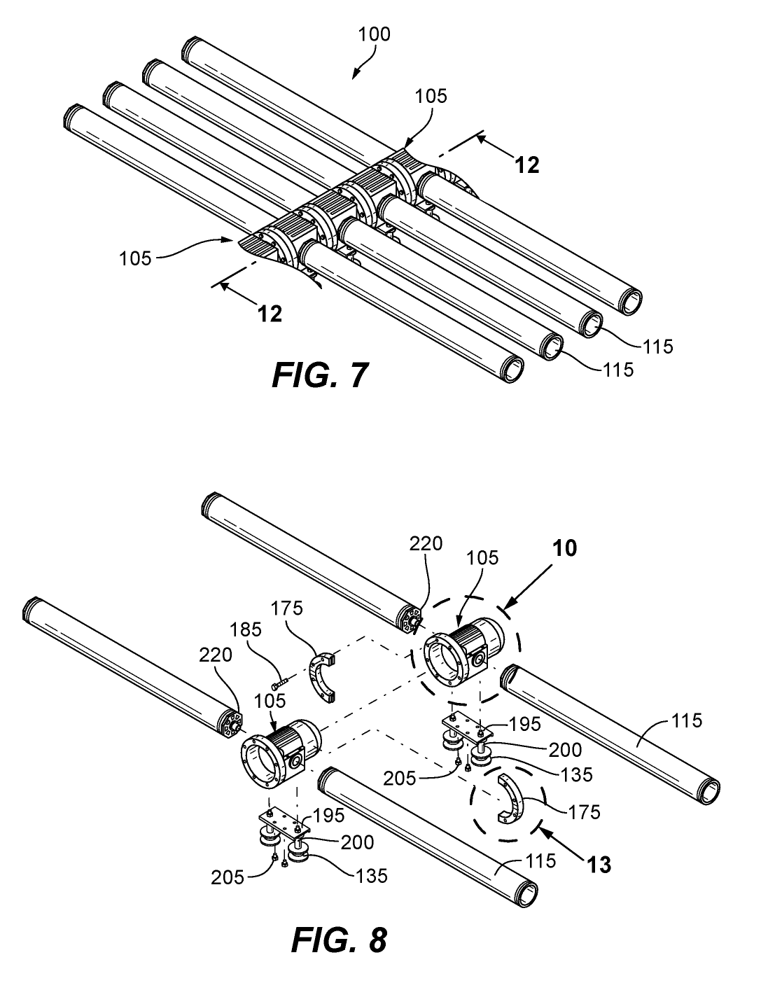

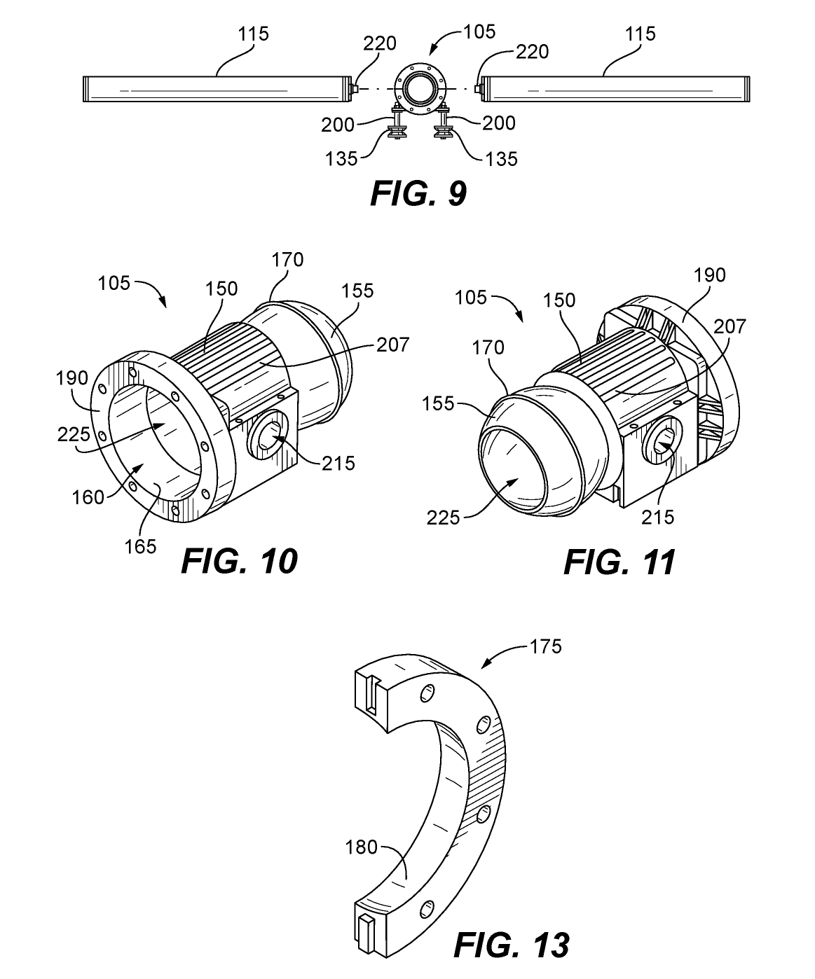

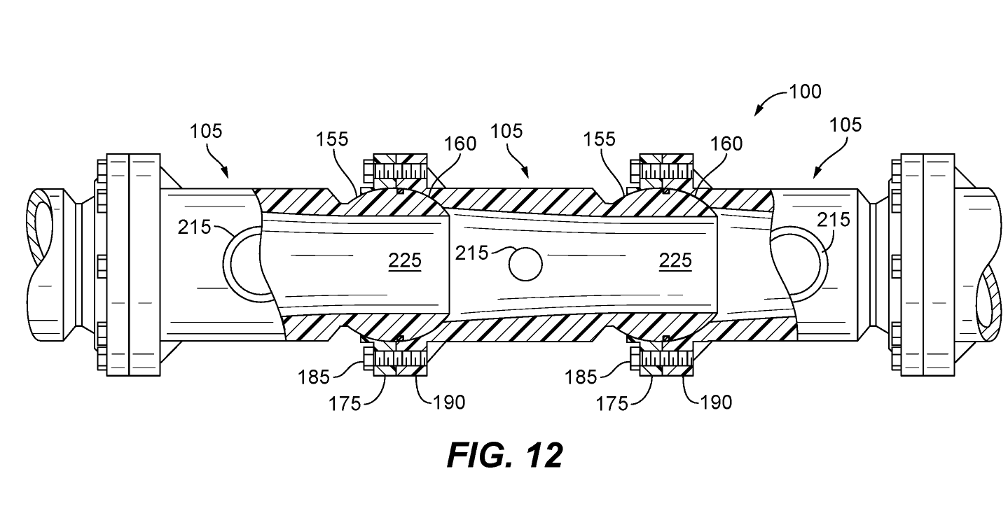

Further details of the pipe modules 105 and the tube diffusers 115 are shown in FIGS. 7-13. FIG. 7 shows a perspective view of several interconnected pipe modules 105 and their tube diffusers 115, while FIG. 8 shows an exploded perspective view of two pipe modules 105 and their associated tube diffusers 115. FIG. 9 shows a front elevational view of a pipe module 105 and its tube diffusers 115, while FIGS. 10 and 11 show front and rear perspective views, respectively, of a pipe module 105. FIG. 12 shows a partially broken side elevational view of several interconnected pipe modules 105 with the sectional cut occurring along the plane indicated in FIG. 7. From these figures, it will become apparent that each pipe module 105 comprises a body 150 that defines a respective partially curved mating surface 155 and a respective partially curved mating cavity 160. Each partially curved mating cavity 160 defines a respective partially curved inside surface 165 that substantially matches the curvature of the partially curved mating surfaces 155. The partially curved mating surface 155 of one pipe module 105 is inserted into the partially curved mating cavity 160 of an adjacent pipe module 105 to link the pipe modules 105 together and to provide the ability of the train of pipe modules 105 to articulate as the pipe modules 105 travel along the track 110. A “ball and socket” means of interconnection is thereby created. An o-ring 170 (formed of, e.g., rubber) captured in a groove on the outside of each partially curved mating surface 155 further aids in forming an airtight and watertight seal at these junctions.

A split flange 175 (i.e., a flange formed of two halves) acts to capture the partially curved mating surface 155 of one pipe module 105 in the partially curved mating cavity 160 of an adjacent pipe module 105. A perspective view of one-half of the split flange 175 is shown in FIG. 13. The split flange has a somewhat curved inner surface 180 that allows it to conform to the partially curved mating surface 155 of the interconnected pipe module 105. Flange bolts 185 attach the split flange 175 to a respective mating flange 190 on each of the pipe modules. Each pair of abutted flanges 175, 190 encircles a respective portion of one of the partially curved mating surfaces 155.

Each pipe module 105 further comprises a respective plate 195 attached to the bottom of its body 150. Each plate supports two shafts 200 and two rollers 135. Plate bolts 205 pass through the plates 195 to attach the plates 195 and into internally threaded receiving holes in the bodies 150.

The bodies 150 of the pipe modules 105 describe grooves 207 in their top and bottom surfaces (FIGS. 10 and 11). In the present embodiment, these grooves 207 both reduce weight, as well as reduce shrinkage when the pipe modules 105 are manufactured by, for example, injection molding.

Attachment of the tube diffusers 115 to the sides of the pipe modules 105 is via threaded receiving holes 215 in the bodies 150 of the pipe modules 105 that are intended to support the tube diffusers 115, in combination with corresponding threaded nipples 220 at a respective end of each one of the tube diffusers 115. The tube diffusers 115 are otherwise conventional and will be familiar to one having ordinary skill in the relevant arts. Aspects of tube diffusers are also described in, as just one example, U.S. Pat. No. 9,440,200 to Frankel et al., entitled “Tube Diffuser,” which is hereby incorporated by reference herein.

With respect to the transport of pressurized air, each pipe module 105 defines a respective gas passage 225 passing therethrough, which, in turn, merges with the two respective receiving holes 215 of each pipe module 105 (FIGS. 10-12). Each pipe module therefore supports gaseous communication between its two tube diffusers 115 and its internal gas passage 225. At the same time, each of the gas passages 225 of the plurality of pipe modules 105 in the train of pipe modules 105 is in gaseous communication with the other gas passages 225 of the other pipe modules 105 in the train (FIG. 12). At the very end of the train of pipe modules 105 (opposite the source of pressurized air 1035), a blank-off flange replaces the split flange 175 and acts to create an airtight/watertight seal so that the collection of gas passages is isolated from the surrounding wastewater. The result is that each of the plurality of tube diffusers 115 is in gaseous communication with the gas passages 225 of the plurality of pipe modules 105. When pressurized air is supplied to the train of pipe modules 105, the pipe modules 105 route this pressurized air to the tube diffusers 115, which ultimately release it in the form of bubbles into the surrounding wastewater.

Configured in the manner shown in FIGS. 1-13, the train of pipe modules 105 may be deployed into the wastewater treatment tank 1000 to provide aeration to that wastewater treatment tank 1000 (FIG. 3). Later, when maintenance is required, the train of pipe modules 105 may be retrieved from the wastewater treatment tank 1000 (FIG. 1). Both operations may be aided by the winch 1025. Once retrieved, the pipe modules 105 and the tube diffusers 115 may be maintained outside the wastewater treatment tank 1000 on the ledge 1005. There is no need to drain the wastewater treatment tank 1000 or to enter the wastewater treatment tank 1000.

It should again be emphasized that the above-described embodiments of the invention are intended to be illustrative only. Other embodiments can use different types and arrangements of elements for implementing the described functionality. These other embodiments would also fall within the scope of the invention.

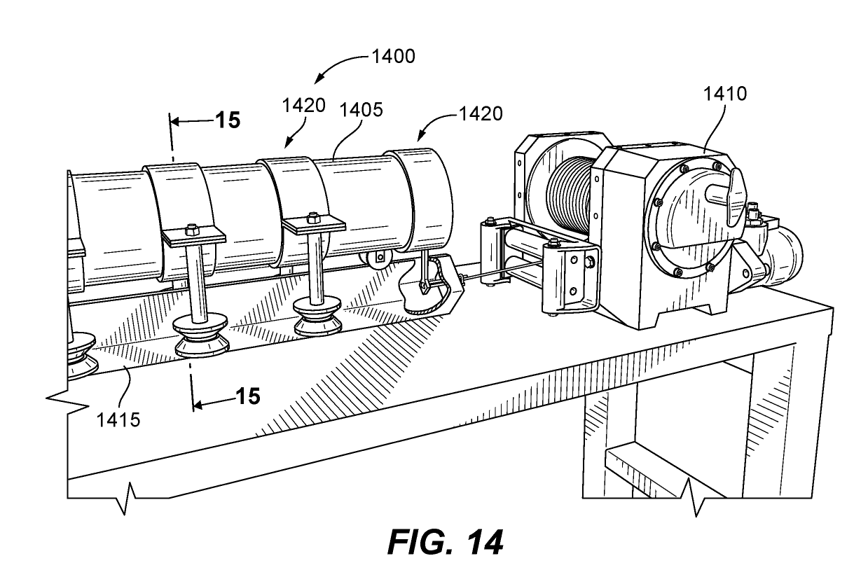

For example, while the retrievable aeration system 100 shown in the figures above is formed of interconnected pipe modules 105 for its entire length, in alternative embodiments, some portion of those pipe modules 105 may be replaced by a flexible pipe. FIG. 14 shows a partially-broken perspective view of a portion of a first alternative retrievable aeration system 1400 in accordance with a first alternative illustrative embodiment of the invention. In this figure, a flexible pipe 1405 replaces the front of the train where it approaches a winch 1410. The flexible pipe 1405 is translatably coupled to a track 1415. Further along in the train (away from the winch 1410; not shown), a series of interconnected pipe modules like those shown in FIG. 7 attach to this flexible pipe 1405, and function in the manner described above. An interior of the flexible pipe 1405 is thereby placed into gaseous communication with the interconnected gas passages of the plurality of pipe modules that follow it. It is contemplated that replacing some portion of the pipe modules with the flexible pipe 1405 in this manner may aid in reducing both cost and complexity.

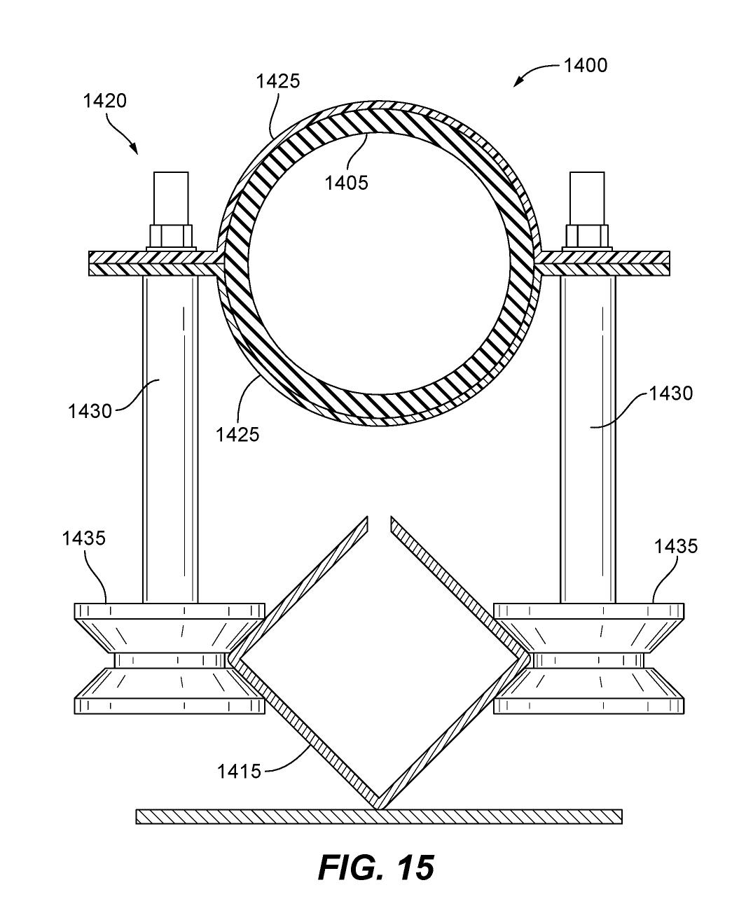

In the first alternative retrievable aeration system 1400, the flexible pipe 1405 is supported by a series of spaced-apart pipe support assemblies 1420 placed along its length. FIG. 15 shows a sectional view through one of these pipe support assemblies 1420 along the plane indicated in FIG. 14. The pipe support assembly 1420 includes two brackets 1425 which encircle the flexible pipe 1405 and capture it via compression. Two shafts 1430 are attached to these brackets and terminate in two rollers 1435. The rollers 1435 allow the pipe support assembly 1420 to translate along the track 1415 as the first alternative retrievable aeration system 1400 is deployed-into and withdrawn-from a wastewater treatment tank in the manner of the retrievable aeration system 100 (FIGS. 1-3). When deployed, a source of pressurized air is attached to an end of the flexible pipe 1405.

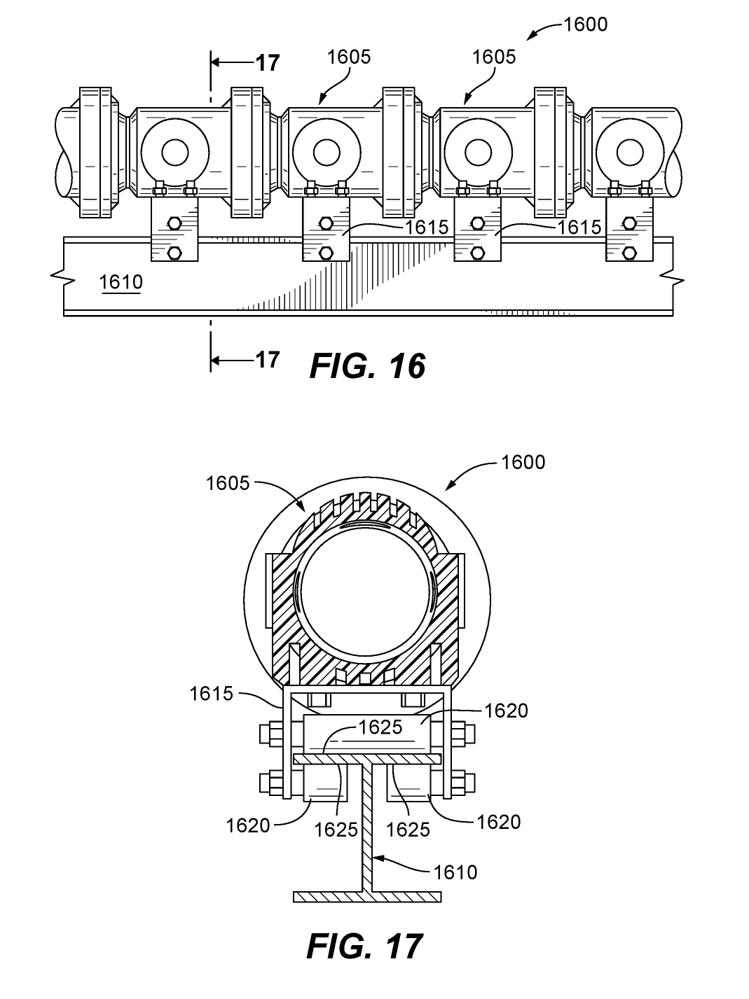

In other alternative embodiments falling within the scope of the invention, different forms of track may be utilized. FIG. 16 shows a side elevational view of a second alternative retrievable aeration system 1600 in accordance with a second alternative illustrative embodiment of the invention, while FIG. 17 shows a sectional view of the second alternative retrievable aeration system 1600 along the plane indicated in FIG. 16. In this embodiment, a train of pipe modules 1605 is translatably coupled to a track 1610, which is in the form of an I-beam. Each pipe module 1605 includes a respective bracket 1615 that is coupled to three respective rollers 1620, which engage three surfaces of the I-beam-shaped track 1625. It is contemplated that the I-beam-shaped track 1610 would be deployed in a manner similar to the diamond-shaped track 110 in FIGS. 1-3, that is, the I-beam-shaped track 1610 would follow the floor of a wastewater treatment tank, ascend vertically along a sidewall of the wastewater treatment tank, and then run above and parallel to a ledge adjacent to the wastewater treatment tank (e.g., on a moveable table with a winch at one end). While a diamond-shaped and I-beam shaped track are explicitly shown in the attached figures, it is again reinforced that a myriad of other track shapes would also be viable, and these additional shapes would also come within the scope of the present invention. Alternative tracks could, as just a few more examples, be rectangular, round, pentagonal, or hexagonal in cross-section.

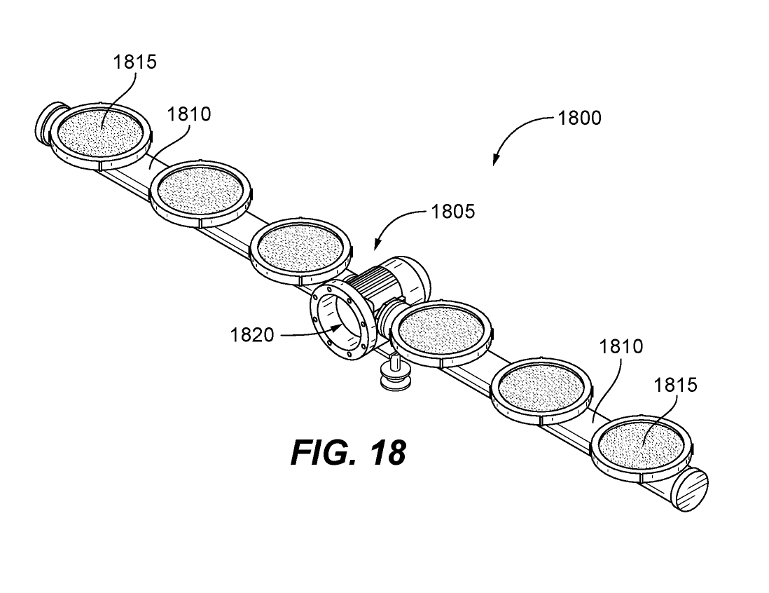

Lastly, in even other alternative embodiments of the invention, a retrievable aeration system may use diffusers different from those utilized above. FIG. 18 shows a perspective view of a portion of a third alternative retrievable aeration system 1800 in accordance with a third alternative illustrative embodiment of the invention. A pipe module 1805 in the third alternative retrievable aeration system 1800 is coupled to two respective conduits 1810, which each support three respective disc diffusers 1815. The respective interiors of each of the two conduits is in gaseous communication with an internal gas passage 1820 that passes through the pipe module 1805. Each disc diffuser 1815, in turn, is in gaseous communication with the interior of its respective conduit 1810. The disc diffusers 1815 are thereby in gaseous communication with the gas passage 1820 of the pipe module 1805. As before, the pipe module 1805 may be formed into a train of interconnected pipe modules 1805 and translatably coupled to a track so that the retrievable aeration system functions 1800 in a manner similar to the retrievable aeration system 100. Even other embodiments of retrievable aeration systems may include only one diffuser (e.g., a single disc diffuser) per pipe module, with the single diffuser attached to the top of the pipe module.

Disc diffusers (also called “fine bubble diffusers”) are commonly available, and their construction and function will already be familiar to one having ordinary skill in the art. They are also described in, for example, U.S. Pat. No. 9,498,756 to Frankel et al., entitled “Assembly for Wastewater Treatment,” which is hereby incorporated by reference herein.

The pipe modules 105, 1605, 1805 set forth above may be formed of any suitable material, including, as just one example, plastic. In one or more embodiments, the plastic pipe modules 105, 1605, 1805 may be formed by injection molding. Injection molding will be familiar to one having ordinary skill in the relevant manufacturing arts. It is also described in, for example, D. V. Rosato et al., “Injection Molding Handbook,” Springer Science and Business Media, 2012, which is hereby incorporated by reference herein. The tracks 110, 1610 may be formed of, for example, metal (e.g., stainless steel).

The above described embodiments, and more generally, embodiments in accordance with aspects of the invention have several advantages. As just indicated, many components may be formed of economical materials, like plastic. At the same time, although retrievable from a wastewater treatment tank and serviceable outside the tank, the retrievable aeration systems do not require three-dimensional tubular or cable frames, and do not require cranes, boom trucks, or boats for maintenance. Instead, a light-duty winch may be utilized. The retrievable aerations systems are also modular, meaning that they may be mass produced, stored and shipped in boxes, and there is little or no need for any custom metal or plastic fabrication.

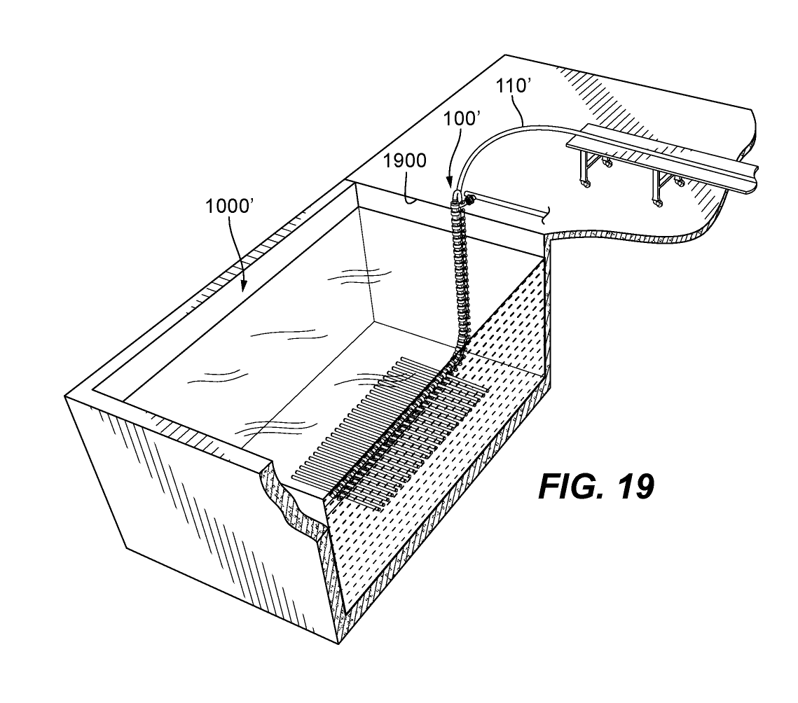

At the same time, retrievable aeration systems in accordance with aspects of the invention may accommodate many different types of diffusers, and can be maintained on narrow concrete walkways (i.e., ledges) between wastewater treatment tanks. If necessary, for example, the trains of pipe modules may be made to make several 90-degree turns to accommodate the layout of the wastewater treatment facility, even passing over obstructions such as guardrails and the like. FIG. 19 shows a perspective view of a retrievable aeration system 100′ similar to the retrievable aeration system 100, but with a track 110′ made to parallel an edge 1900 of a wastewater treatment tank 1000′. Configured in this manner, the retrievable aeration system 100′ may be accommodated by a much narrower ledge than the retrievable aeration system 100, but otherwise functions in a similar manner.

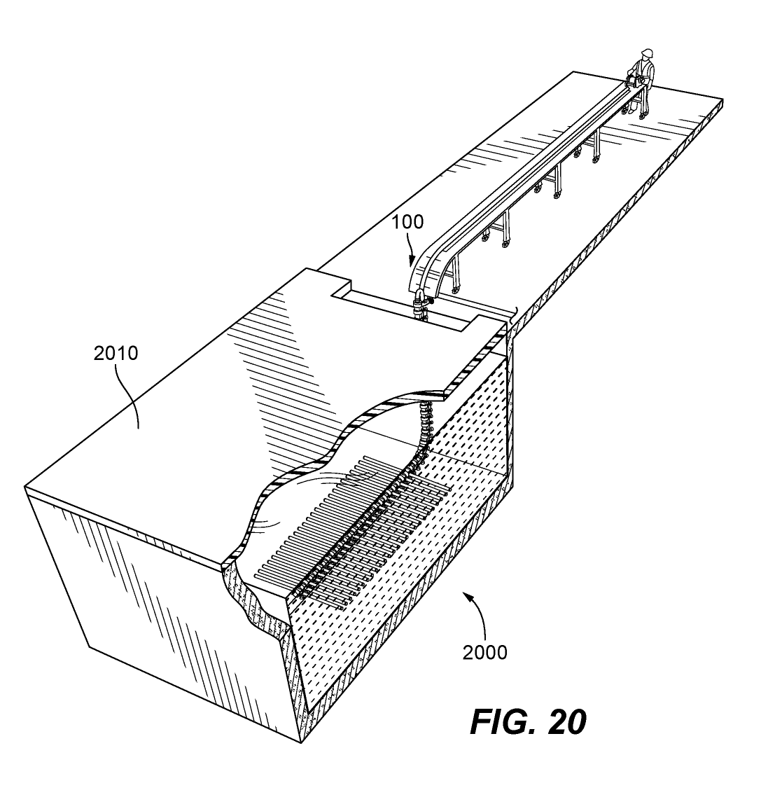

After maintenance, retrievable aeration systems in accordance with aspects of the invention can be re-installed into a wastewater-filled wastewater treatment tank, and, because they are translated along a fixed track, will return to the same position in the wastewater treatment tank, unlike liftable grids which typically require a lot of clearance when being dropped back into place in a filled wastewater treatment tank so that they do not strike or overlap the next grid. Locking mechanisms may be added to the retrievable aeration systems to lock the systems in a particular place on their track if deemed necessary. These locking mechanisms may be actuated by one or more cables accessible outside the wastewater treatment tank. Once in place, the present retrievable aeration systems with their fixed tracks will resist any horizontal loads from flow boosters and the like. Retrievable aeration systems in accordance with aspects of the invention may also be readily retrieved from and deployed into covered wastewater treatment tanks without needing to remove the cover. FIG. 20 shows a perspective view of the retrievable aeration system 100 deployed in a wastewater treatment tank 2000 that is covered by a cover 2010.

All the features disclosed herein may be replaced by alternative features serving the same, equivalent, or similar purposes, unless expressly stated otherwise. Thus, unless expressly stated otherwise, each feature disclosed is one example only of a generic series of equivalent or similar features.

Any element in a claim that does not explicitly state “means for” performing a specified function or “step for” performing a specified function is not to be interpreted as a “means for” or “step for” clause as specified in AIA 35 U.S.C. § 112(f). In particular, the use of “steps of” in the claims herein is not intended to invoke the provisions of AIA 35 U.S.C. § 112(f).

What is claimed is:

1. An apparatus for use with a wastewater treatment tank, the apparatus comprising:
a track;
a plurality of pipe modules coupled to the track such that the plurality of pipe modules are translatable along the track, each pipe module of the plurality of pipe modules defining a respective partially curved mating surface, a respective partially curved mating cavity, and a respective gas passage passing therethrough; and
a plurality of diffusers attached to the plurality of pipe modules;
wherein the respective partially curved mating surface of a first pipe module of the plurality of pipe modules is inserted into the respective partially curved mating cavity of a second pipe module of the plurality of pipe modules;
wherein the respective partially curved mating surface of the second pipe module of the plurality of pipe modules is inserted into the respective partially curved mating cavity of a third pipe module of the plurality of pipe modules;
wherein each gas passage of the plurality of pipe modules is in gaseous communication with the other gas passages of the plurality of pipe modules;
wherein each diffuser of the plurality of diffusers is in gaseous communication with the gas passages of the plurality of pipe modules.

2. The apparatus of claim 1, wherein the track runs along a bottom and up a sidewall of the wastewater treatment tank.

3. The apparatus of claim 1, further comprising a ledge adjacent to the wastewater treatment tank.

4. The apparatus of claim 3, wherein the track runs above the ledge.

5. The apparatus of claim 4, wherein a portion of the track above the ledge runs substantially parallel to an edge of the wastewater treatment tank.

6. The apparatus of claim 4, further comprising a table supporting the track above the ledge.

7. The apparatus of claim 1, wherein a cross-section of the track defines four external flat surfaces and three corners.

8. The apparatus of claim 1, wherein the track defines a slot.

9. The apparatus of claim 1, wherein a cross-section of at least a portion of the track defines an I-beam.

10. The apparatus of claim 1, wherein the first pipe module comprises one or more rollers pressed against the track.

11. The apparatus of claim 1, wherein the second pipe module comprises a pair of abutted flanges encircling a portion of the partially curved mating surface of the first pipe module.

12. The apparatus of claim 11, wherein one of the pair of abutted flanges is a split flange.

13. The apparatus of claim 1, wherein at least one of the plurality of diffusers is a tube diffuser.

14. The apparatus of claim 13, wherein:
the first pipe module defines a receiving hole; and
the tube diffuser comprises a nipple that is threadably engaged in the receiving hole.

15. The apparatus of claim 1, further comprising
a conduit supported by the first pipe module and defining an interior in gaseous communication with the gas passage of the first pipe module; and
a disc diffuser supported by the conduit and in gaseous communication with the interior.

16. The apparatus of claim 1, further comprising a flexible pipe in gaseous communication with the gas passages of the plurality of pipe modules.

17. The apparatus of claim 16, wherein the flexible pipe is translatably coupled to the track.

18. A method for treating wastewater in a wastewater treatment tank, the method comprising the steps of:
installing a track;
coupling a plurality of pipe modules to the track such that the plurality of pipe modules are translatable along the track, each pipe module of the plurality of pipe modules defining a respective partially curved mating surface, a respective partially curved mating cavity, and a respective gas passage passing therethrough; and
attaching a plurality of diffusers to the plurality of pipe modules;
wherein the respective partially curved mating surface of a first pipe module of the plurality of pipe modules is inserted into the respective partially curved mating cavity of a second pipe module of the plurality of pipe modules;
wherein the respective partially curved mating surface of the second pipe module of the plurality of pipe modules is inserted into the respective partially curved mating cavity of a third pipe module of the plurality of pipe modules;
wherein each gas passage of the plurality of pipe modules is in gaseous communication with the other gas passages of the plurality of pipe modules;
wherein each diffuser of the plurality of diffusers is in gaseous communication with the gas passages of the plurality of pipe modules.

19. A wastewater treatment system comprising:
a wastewater treatment tank;
a track, a portion of the track occupying the wastewater treatment tank;
a plurality of pipe modules being coupled to the track such that the plurality of pipe modules are translatable along the track, each pipe module of the plurality of pipe modules defining a respective partially curved mating surface, a respective partially curved mating cavity, and a respective gas passage passing therethrough; and
a plurality of diffusers attached to the plurality of pipe modules;
wherein the respective partially curved mating surface of a first pipe module of the plurality of pipe modules is inserted into the respective partially curved mating cavity of a second pipe module of the plurality of pipe modules;
wherein the respective partially curved mating surface of the second pipe module of the plurality of pipe modules is inserted into the respective partially curved mating cavity of a third pipe module of the plurality of pipe modules;
wherein each gas passage of the plurality of pipe modules is in gaseous communication with the other gas passages of the plurality of pipe modules;
wherein each diffuser of the plurality of diffusers is in gaseous communication with the gas passages of the plurality of pipe modules.

20. The wastewater treatment system of claim 19, wherein the plurality of pipe modules are translatable along the track into and out of the wastewater treatment tank with wastewater occupying the wastewater treatment tank.

21. The wastewater treatment system of claim 19, further comprising a cover at least partially covering the wastewater treatment tank.
